(19) United States
(12) Patent Application Publication
(10) Pub. No.: US 2005/0006355 A1
(43) Pub. Date: Jan. 13, 2005

(54) Device and method for hybrid welding

(76) Inventors: Guillaume De Dinechin, Moulineaux (FR); Aubert Philippe, Paris (FR)

Correspondence Address: PEARNE & GORDON LLP, 1801 EAST 9TH STREET, SUITE 1200, CLEVELAND, OH, 44114-3108, US

(21) Appl. No.: 10/495,910

(22) PCT Filed: Nov. 19, 2002
(86) PCT No.: PCT/FR02/03943

(30) Foreign Application Priority Data
Nov. 22, 2001 (FR) 01/15122

(51) Int. Cl. B23K 26/20; B23K 9/00

(52) U.S. Cl. 219/121.63; 219/137 R

(57) ABSTRACT

This invention relates to a hybrid welding device (1) comprising laser welding means. (2) and electric arc welding means (4) with meltable electrode (6). The device (1) according to the invention is made such that the meltable electrode (6) has an approximately rectangular cross-section. This invention also relates to a hybrid welding method that can be used by such a device. Application to the automobile field.

### TECHNICAL DOMAIN

The invention relates to the domain of hybrid welding combining laser welding and electric arc welding with metallic filler wire.

More particularly, the technical domain of the invention relates to hybrid welding devices and methods in which the electric arc welding uses a meltable electrode.

### STATE OF PRIOR ART

There are many embodiments of hybrid welding methods in prior art.

Hybrid welding methods are known that simultaneously combine a laser welding operation and an electric arc welding operation, the main purpose of this combination being to be able to benefit from all the advantages of each of the two welding techniques.

The laser welding operation is made either using an Nd-YAG type laser source, or using a CO₂ type laser source. This welding method is very widely used in the industrial field, and provides a means of making narrow and deep welds at high speeds, only causing small deformation of parts to be assembled. These advantages are essentially due to the very high energy density input by the laser beam used.

On the other hand, the use of this type of laser welding method requires a very difficult preparation of parts to be welded. Thus, one of the conditions required to achieve a good quality weld is to obtain the smallest possible clearance between the different parts to be assembled. Furthermore, this laser welding method is very expensive, since the equipment investments necessary to use this technique are very high.

Due to the problems mentioned above related to laser welding methods, it has been proposed to combine a laser welding method with an electric arc welding method.

Electric arc welding methods are widely used in the industrial environment, and are inexpensive and less critical in terms of preparation of parts to be welded. However, these methods are used at very low speeds compared with execution speeds for laser welding methods, and also cause large deformation of parts. Another disadvantage related to this type of method is the difficulty of deep penetration in parts to be welded.

There are three main types of techniques among these methods of electric arc welding that can be combined with a laser welding method.

Firstly, there is the Metal Inert Gas/Metal Active Gas (MIG/MAG) welding technique implemented from an electric arc created and maintained between an electrode filler wire that may be solid or may be packed with oxide and/or metallic powders, unwinding continuously at constant speed, and a part to be welded. The heat energy of the electric wire makes the part to be assembled and the filler electrode wire melt locally, to create a molten bath.

Prior art also includes the Tungsten Inert Gas (TIG) welding technique in which an electric arc is created and maintained between a non-meltable tungsten electrode and the part to be welded. In this case, the filler metal is brought up manually or automatically with a motor controlled unwinder in a molten bath.

Finally, an electric arc welding technique of the type using a plasma arc can also be used. This technique is very similar to the TIG welding technique described above. The electric arc is created between a non-meltable electrode, preferably made of tungsten, and the part to be welded inside a nozzle located inside a special plasma welding torch. This nozzle enables constriction or mechanical throttling of the electric arc through a calibrated orifice in a central or plasmagenic gas column, that generates a very high thermal energy. This thermal energy locally melts the part to be assembled and a manually or automatically added filler wire if there is one, in order to form a molten bath.

For example, this type of hybrid welding method is described in document U.S. Pat. No. 4,507,540. In this document, the two methods (laser welding and electric arc welding) are combined using the MIG/MAG welding technique. According to this document, a part to be welded is molten using the MIG/MAG electric arc in order to generate a crater formed by molten metal drops ejected from one end of a filler electrode wire. The next step is to focus a laser beam on the crater formed, which enables an increase in the welded thickness.

Therefore, in all embodiments according to prior art, the required objective is to use an optimized welding method, both from the technical point of view and from the economic point of view.

However, even if combinations according to prior art are sufficient to obtain a synergy effect between laser welding methods and electric arc welding methods, the methods described are not always satisfactory in terms of welding time.

To satisfy continuously increasing industrial needs, there is a need to use new methods reducing welding times while keeping or increasing the deposition rate, or to obtain methods increasing the deposition rate while keeping or reducing welding times.

Document U.S. Pat. No. 5,821,493 proposed to implement a particular hybrid welding method largely to overcome these disadvantages concerning the welding time, using a laser welding device and two other electric arc welding devices. According to this document, the fact of placing an additional arc welding source, in fact the TIG type welding device, increases the energy input by the laser. Consequently, this addition makes it possible to weld at higher speeds, while maintaining the same deposition rate.

Although this particular combination of three different welding devices reduces the welding time, it is still very expensive to use and is very large.

### OBJECT OF THE INVENTION

The purpose of this invention is to at least partially overcome the disadvantages mentioned above with hybrid welding methods and devices according to prior art.

Therefore, the purpose of the invention is to present a hybrid welding device with a simple design and a hybrid welding method that can be used by such a device, this device and this method enabling high welding speeds, while maintaining a high deposition rate.

To achieve this, the primary object of the invention is a hybrid welding device comprising laser welding means and electric arc welding means with a meltable electrode. The device according to the invention is made such that the meltable electrode has an approximately rectangular cross-section.

This specific characteristic of the invention advantageously enables the device to generate a deposition rate greater than the rate usual with devices according to prior art at a similar speed. Similarly, the welding speed can be increased while maintaining exactly the same deposition rate than can be obtained with devices according to prior art, or increasing this rate. These advantages are due to the fact that by using such a meltable electrode, the plasma column created between the meltable electrode and parts to be welded is considerably widened, and the section of deposited metal is increased. The consequences resulting from this specific characteristic are greater channeling of heat energy within the plasma, particularly energy originating from the part of the laser beam reflected on the parts to be welded, and a limitation of the excavation effect caused by the electric arc formed. It is then possible to weld at even higher speeds, while obtaining acceptable technical and morphological characteristics for the weld bead generated.

Preferably, the approximately rectangular cross-section of the meltable electrode includes a width of between 0.5 mm and about 0.6 mm, and a length varying between about 3.5 mm and about 4 mm.

Moreover, the meltable electrode could be a solid meltable electrode or a filled meltable electrode.

Thus, when a filled meltable electrode is used, the flux that originates from the powder filling performs its metallurgical role and protects the weld bead against oxidation, but it also forms a slag as it solidifies that protects and keeps the molten bath in place, particularly for welding in position. This characteristic is particularly advantageous in the case of a large melting bath, this case arising particularly during welding operations on thick parts, to prevent this bath from flowing by gravity.

Preferably, laser welding means are chosen from among welding means using an Nd-YAG type laser source and welding means using a CO₂ type laser source. Moreover, electric arc welding means are chosen from among welding means capable of using a MIG type welding operation and means capable of implementing a MAG type welding operation.

Thus, the use of two sets of means known according to prior art and frequently used in industry, can advantageously reduce the size and cost of the device, particularly compared with a combination of three distinct welding devices.

Another purpose of the invention is a hybrid welding method simultaneously combining a laser welding operation and an electric arc welding operation with a meltable electrode. This method according to the invention can be implemented by a device such as the device according to the invention and described below.

Other characteristics and advantages of the invention will appear in the non-limitative description given below.

### BRIEF DESCRIPTION OF THE DRAWINGS

This description will be made with reference to the attached drawings among which:

FIG. 1 shows a diagrammatic view of a device according to a preferred embodiment of the invention, and

FIG. 2 shows a section taken through line A-A in FIG. 1.

### DETAILED DESCRIPTION OF PREFERRED EMBODIMENTS

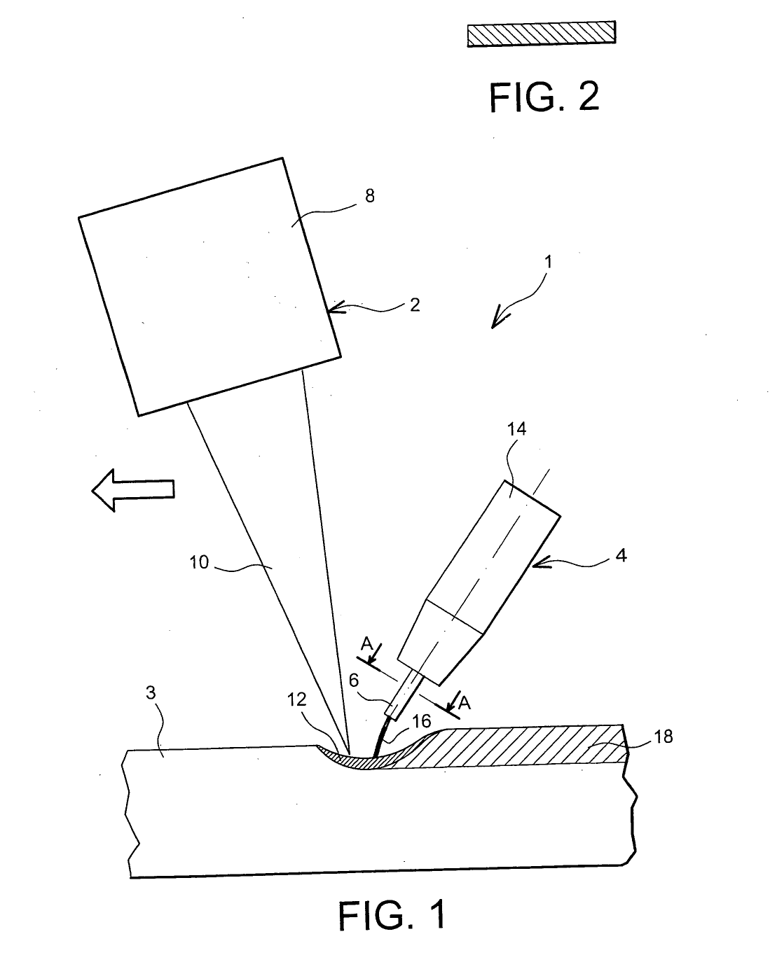

FIG. 1 shows a hybrid welding device 1 according to a preferred embodiment of the invention, this device 1 being designed to assemble two parts 3 to each other by welding.

The device 1 comprises laser welding means 2 and electric arc welding means with a meltable electrode 6.

The laser welding means 2 use an Nd-YAG type or CO₂ type laser source 8. One or the other of these laser sources 8 can be used indifferently, the main difference between the two being that the Nd-YAG type source uses optical fibers for the transport of a laser beam 10. Consequently, this specific characteristic increases the flexibility of the welding head.

The laser beam 10 focuses one portion of the parts 3 composed of a molten metal bath 12.

The electric arc welding means 4 use a meltable electrode 6. In other words, the metal added to make a weld bead 18 on the parts to be welded 3 is made by the meltable electrode 6, which is consumed as this weld bead 18 is formed.

Electric arc welding means 4 are indifferently means that can implement a MIG welding operation and means that can-implement a MAG welding operation.

Therefore means 4 comprise a welding torch 14 connected to a motor driven unwinder (not shown) in which the meltable electrode 6, also called the filler wire, is located. An electric arc 16 is formed between the meltable electrode 6 and the parts to be welded, in the melting metal bath 12.

Therefore the two sets of welding means 2 and 4 converge towards the same molten metal bath 12, their combination causing a synergy effect with regard to the welding characteristics obtained.

According to the invention, the meltable electrode 6 is made such that a cross-section of this meltable electrode 6 has an approximately rectangular shape. Thus, a plasma column between the meltable electrode 6 and the parts to be welded 3 is widened, to limit the excavating effects of an electric arc 16 and to increase the section of metal deposited. Due to the widening of the plasma, the deposition rate of the filler wire on the parts to be welded 3 is increased, which also enables an increase in the welding speed and/or the deposition rate.

Preferably and with reference to FIG. 2, the approximately rectangular cross-section comprises a width measuring between about 0.5 mm and about 0.6 mm, and a length measuring between about 3.5 mm and about 4 mm. Obviously, those skilled in the art could adapt these measurements as a function of the various welding conditions that they need to deal with.

The meltable electrode 6 may be of any type. It may be a solid meltable electrode, also called a solid filler wire, or a filled meltable electrode. In this case, note particularly there are the “basic” and “titanium dioxide” types of filled electrodes, and the use of these types of electrodes can give better positional support of the melting bath, particularly due to the presence of slag.

These filled meltable electrodes are composed particularly of oxide and/or metallic type powders.

Note that use of filled meltable electrodes can further increase the welding speed and/or the deposition rate compared with the use of solid filler wires.

The method according to the invention can be illustrated with reference to FIG. 1. It combines a laser welding operation and an electric arc welding operation. Furthermore, the method according to the invention can be used by a hybrid welding device like that described above.

One of the particular characteristics of this welding method is that it carries out electric arc welding with a meltable electrode 6 with an approximately rectangular shaped cross-section, and can be implemented in different ways.

Thus, it is possible to weld in the “pushed” position, namely in the position in which an angle formed between a main welding direction shown by the arrow, and a main axis of the welding torch 14 supporting the meltable electrode 6, is more than 90°. This configuration is shown in FIG. 1.

Similarly, it would be possible to weld in the “pulled” position (this case is not shown), namely in a case in which the angle formed between a main welding direction and the main axis of the welding torch 14 supporting the meltable electrode 6, is less than 90°.

In both of the positions mentioned above, the meltable electrode 6 may be in two distinct positions on the welding torch 14. Note that the meltable electrode 6 may also be in any arbitrary intermediate position, this position being located between a transverse position and an aligned position, the choice being made as a function of measurements to be adopted by those skilled in the art.

If we consider that the approximately rectangular cross-section of the meltable electrode 6 comprises a width and a length, then in a first case the width of this cross-section is perpendicular to the main welding direction.

In a second case, the length of the cross-section of the approximately rectangular cross-section is perpendicular to the main welding direction.

Consequently, it can be seen that many configurations of device 1 are possible to implement the method according to the invention.

This device 1 and this hybrid welding method may be applicable to any industrial domain with welded construction needs, particularly in the automobile field.

Obviously, those skilled in the art could make many modifications to the hybrid welding device and method that have just been described as non-limitative examples only.

1. Hybrid welding device comprising laser welding means and electric arc welding means with meltable electrode, characterized in that the meltable electrode has an approximately rectangular cross-section.

2. Welding device (1) according to claim 1, characterized in that the approximately rectangular cross-section includes a width of between about 0.5 mm and about 0.6 mm, and a length varying between about 3.5 mm and about 4 mm.

3. Welding device according to claim 1, characterized in that the meltable electrode is an electrode taken from among solid meltable electrodes and filled meltable electrodes.

4. Welding device (1) according to claim 1, characterized in that the laser welding means are chosen from among welding means using an Nd-YAG type laser source and welding means using a CO₂ type laser source.

5. Welding device according to claim 1, characterized in that the electric arc welding means are chosen from among welding means capable of using a MIG type welding operation and means capable of implementing a MAG type welding operation.

6. Hybrid welding method simultaneously combining a laser welding operation and an electric arc welding operation with a meltable electrode, characterized in that the method can be implemented by a device according to any one of the above claims.

7. Welding method according to claim 6, characterized in that an angle formed between a main welding direction and a main axis of a welding torch supporting the meltable electrode is more than 90°.

8. Welding method according to claim 6, characterized in that an angle formed between a main welding direction and a main axis of the welding torch supporting the meltable electrode is less than 90°.

9. Welding method according to claim 7 or 8, characterized in that a width of the approximately rectangular cross-section is perpendicular to the main welding direction.

10. Welding method according to claim 7 or 8, characterized in that a length of the approximately rectangular cross-section is perpendicular to the main welding direction.
